(19) United States
(12) Patent Application Publication
(10) Pub. No.: US 2014/0030625 A1
(43) Pub. Date: Jan. 30, 2014

(54) VOLTAGE REVERSAL TOLERANT FUEL CELL WITH SELECTIVELY CONDUCTING ANODE

(71) Applicants: Ford Motor Company, Dearborn, MI (US); Daimler AG, Stuttgart (DE)

(72) Inventors: Herwig Haas, Surrey (CA); Joy Roberts, Coquitlam (CA); Francine Berretta, Vancouver (CA); Amy Shun-Wen Yang, Port Coquitlam (CA); Stephen Lee, New Westminster (CA); Sima Ronasi, North Vancouver (CA)

(21) Appl. No.: 13/949,414

(22) Filed: Jul. 24, 2013

Related U.S. Application Data
(60) Provisional application No. 61/676,891, filed on Jul. 27, 2012.

(51) Int. Cl. H01M 4/86

(52) U.S. Cl. CPC H01M 4/8657
USPC 429/465; 429/480

(57) ABSTRACT

Use of a selectively conducting anode component in solid polymer electrolyte fuel cells can reduce the degradation associated with repeated startup and shutdown, but unfortunately can also adversely affect a cell's tolerance to voltage reversal. Use of a carbon sublayer in such cells can improve the tolerance to voltage reversal, but can adversely affect cell performance. However, employing an appropriate selection of selectively conducting material and carbon sublayer, in which the carbon sublayer is in contact with the side of the anode opposite the solid polymer electrolyte, can provide for cells that exhibit acceptable behaviour in every regard. A suitable selectively conducting material comprises platinum deposited on tin oxide.

### BACKGROUND

1. Field of the Invention

The present invention pertains to fuel cells, particularly to solid polymer electrolyte fuel cells, and to methods and constructions for improving tolerance to voltage reversal while maintaining performance and durability.

2. Description of the Related Art

Sustained research and development effort continues on fuel cells because of the energy efficiency and environmental benefits they can potentially provide. Solid polymer electrolyte fuel cells are particularly suitable for consideration as power supplies in traction applications, e.g. automotive. However, improving the durability of such cells to repeated exposure to startup and shutdown remains a challenge for automotive applications in particular.

Unacceptably high degradation rates in performance can occur in solid polymer electrolyte fuel cells subjected to repeated startup and shutdown cycles. The degradation can be further exacerbated when using low catalyst loadings in the electrodes for cost saving purposes. Often, there is a trade-off between durability and performance in the fuel cell. During the startup and shut-down of fuel cell systems, corrosion enhancing events can occur. In particular, air can be present at the anode at such times (either deliberately or as a result of leakage) and the transition between air and fuel in the anode is known to cause temporary high potentials at the cathode, thereby resulting in carbon corrosion and platinum catalyst dissolution. Such temporary high cathode potentials can lead to significant performance degradation over time. It has been observed that the lower the catalyst loading, the faster the performance degradation. The industry needs to find means to address the performance degradation.

A number of approaches for solving the degradation problem arising during startup and shutdown have been suggested in the art. For example, the problem has been addressed by employing higher catalyst loadings, valves around the stack to prevent air ingress into the anode during storage, and using carefully engineered shutdown strategies. Some suggested systems incorporate an inert nitrogen purge and nitrogen/oxygen purges to avoid damaging gas combinations being present during these transitions. See for example U.S. Pat. No. 5,013,617 and U.S. Pat. No. 5,045,414.

Some other concepts involve fuel cell stack startup strategies involving fast flows to minimize potential spikes. For example, U.S. Pat. No. 6,858,336 and U.S. Pat. No. 6,887,599 disclose disconnecting a fuel cell system from its primary load and rapidly purging the anode with air on shutdown and with hydrogen gas on startup respectively in order to reduce the degradation that can otherwise occur. While this can eliminate the need to purge with an inert gas, the methods disclosed still involve additional steps in shutdown and startup that could potentially cause complications. Shutdown and startup can thus require additional time and extra hardware is needed in order to conduct these procedures.

Recently, in PCT patent application serial number WO2011/076396 by the same applicant which is hereby incorporated by reference in its entirety, it was disclosed that the degradation of a solid polymer fuel cell during startup and shutdown can be reduced by incorporating a suitable selectively conducting component in electrical series with the anode components in the fuel cell. The component is characterized by a low electrical resistance in the presence of hydrogen or fuel and a high resistance in the presence of air (e.g. more than 100 times lower in the presence of hydrogen than in the presence of air).

It was noted in WO2011/076396 however that the presence of a selectively conducting component or layer could potentially lead to a loss in cell performance (due to an increase in internal resistance) and also could lower the tolerance of the fuel cell to voltage reversals. Still, judicious choices of components (e.g. such as those illustrated in the Examples) can be effective for improving durability with only a minimal, acceptable effect on performance. And an adequate remedy for a lowering in voltage reversal tolerance was suggested. Instead of extending the layer of selectively conducting material over the entire active surface of the anode, some regions could be provided where the layer was absent to allow for dissipation of reversal currents and/or provide a sacrificial area in the event of cell reversal. Embodiments were suggested in which more than 10% of the active surface of the anode were absent and/or in which various patterns were used.

Further, it was mentioned that it may be advantageous to keep the selectively conductive layer separate from the anode catalyst. A carbon sublayer may for instance be incorporated between the two for this purpose.

### SUMMARY

Use of a selectively conducting layer component in the anode of a solid polymer electrolyte fuel cell desirably improves startup/shutdown durability. But it has been found to be difficult to simultaneously achieve commercially acceptable voltage reversal tolerance and commercially acceptable performance as well as startup/shutdown durability in this way. For instance, applying a selectively conducting layer only to a portion or portions of an anode component (i.e. partial coverage of selectively conducting layer) can improve voltage reversal tolerance but at the expense of startup/shutdown durability. And also, incorporating a carbon sublayer can provide a solution for voltage reversal tolerance, but it can adversely affect performance. The present invention addresses these problems by incorporating a carbon sublayer in contact with the side of the anode opposite the solid polymer electrolyte, and by appropriately selecting the selectively conducting material and carbon sublayer such that the fuel cell voltage is greater than about 0.5 V when operating at 1.5 A/cm². Surprisingly, this combination of carbon sublayer and appropriately chosen selectively conducting material can be a preferred approach over a partial coverage approach for addressing reversal tolerance problems. The present invention can acceptably meet all these criteria.

More specifically then, the improved solid polymer electrolyte fuel cell comprises a solid polymer electrolyte, a cathode, and anode components connected in series electrically wherein the anode components comprise an anode, an anode gas diffusion layer, the aforementioned carbon sublayer and a selectively conducting component as described in the aforementioned WO2011/076396. The selectively conducting component comprises a selectively conducting material, and the electrical resistance of the selectively conducting component in the presence of hydrogen is more than 100 times lower, and preferably more than 1000 times lower, than the electrical resistance in the presence of air.

Both the carbon layer and the selectively conducting material are also selected such that the fuel cell meets the aforementioned operation requirements. In particular, an appropriate selectively conducting material comprises a noble metal, such as platinum, deposited on a metal oxide, such as tin oxide. An exemplary selectively conducting material comprises about 1% Pt—SnO₂. The selectively conducting component can be incorporated as a layer either on the side of the anode gas diffusion layer adjacent the carbon sublayer or alternatively on the side of the anode gas diffusion layer opposite the carbon sublayer.

The thickness of a practical selectively conducting component can be in the range from about 1 to about 15 micrometers. In exemplary fuel cells, the thickness of the selectively conducting component can be in the range from about 10 to about 15 micrometers. Further, the carbon sublayer can comprise acetylene black or synthetic graphite. And the thickness of the carbon sublayer can be in the range from about 1 to about 10 micrometers, and in certain embodiments for instance about 3 to about 10 micrometers.

Being directed to voltage reversal tolerance, the invention is particularly intended for fuel cell stacks and particularly for those in fuel cell systems which will be subjected to numerous startup and shutdown sequences over the lifetime of the system (e.g. over 1000) because the accumulated effects of degradation will be much more substantial. For instance, the invention is particularly suitable for automotive applications in which the fuel cell system is the traction power supply for the vehicle.

### BRIEF DESCRIPTION OF THE DRAWINGS

FIG. 1 shows an exploded schematic view of the various components making up a unit cell for a solid polymer electrolyte fuel cell stack.

FIG. 2 shows a plot of the reversal time versus the % open area of the anode GDL surface for the series of fuel cells in the Examples made with partial selectively conducting oxide layers.

FIG. 3 shows plots of voltage versus time during voltage reversal testing for some representative cells in the series of fuel cells in the Examples made with varied carbon sublayers and selectively conducting oxide layers.

FIG. 4 shows polarization plots for some representative cells in the series of fuel cells in the Examples made with varied carbon sublayers and selectively conducting oxide layers.

### DETAILED DESCRIPTION

Herein, in a quantitative context, the term “about” should be construed as being in the range up to plus 10% and down to minus 10%.

Solid polymer electrolyte fuel cells of the invention comprise anode components including a selectively conducting anode component and a carbon sublayer in contact with the side of the anode opposite the solid polymer electrolyte. The use of the selectively conducting anode component provides for improved durability on startup and shutdown, while the presence of the carbon sublayer mitigates against associated losses in voltage reversal tolerance. However, to additionally mitigate against associated losses in cell performance, the combination of selectively conducting material and carbon sublayer is selected such that the fuel cell voltage is greater than about 0.5 V when operating at 1.5 A/cm². Combinations in which the selectively conducting material comprises platinum deposited on tin oxide are suitable in this regard.

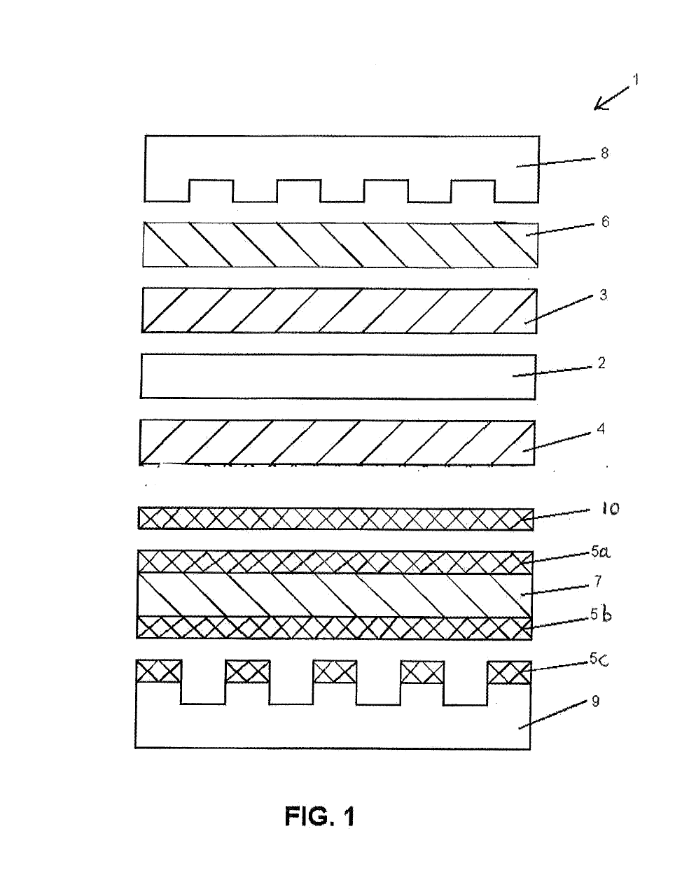

Except for the choice of selectively conducting material and carbon sublayer, the construction of the fuel cell, and stacks thereof, can be any of the conventional constructions known to those in the art. FIG. 1 shows an exploded schematic view of the various components making up a unit cell for a solid polymer electrolyte fuel cell stack of the invention. Unit cell 1 comprises a solid polymer electrolyte 2, cathode 3, and anode 4. Adjacent the two cathode and anode electrodes are cathode GDL 6 and anode GDL 7 respectively. Adjacent these two GDLs are cathode flow field plate 8 and anode flow field plate 9 respectively.

The selectively conducting component is incorporated in electrical series with the anode components. As shown in FIG. 1, this selectively conducting component can be incorporated in various ways. For instance, the selectively conducting component can be located on either side of anode GDL 7, i.e. as layer 5a or layer 5b, or it can form part of flow field plate 9, i.e. layer 5c. Further, the selectively conducting component can be provided in any of these locations as a coating or part of the component or as a discrete layer. Finally, carbon sublayer 10 is located in contact with the side of anode 4 opposite solid polymer electrolyte 2.

As illustrated in the Examples below, platinum deposited on tin oxide is suitable for use as the selectively conducting material in the selectively conducting component. In particular, the selectively conducting material can be 1% Pt—SnO₂.

The selectively conducting component is then to be engineered such that it provides the desired electrical resistance and overall cell performance characteristics. In this regard, thicknesses for the selectively conducting component in the range from about 10 to about 15 micrometers can be effective.

Further, acetylene black or synthetic graphite can be suitable for use in the carbon sublayer. This sublayer is also to be engineered such that it provides the desired overall cell performance characteristics. In this regard, thicknesses for the carbon sublayer in the range from about 3 to about 10 micrometers can be effective.

Methods for incorporating noble metals on a metal oxide, methods for making appropriate dispersions for coating selectively conducting layers and for performing the coating, and other engineering considerations are discussed in detail in WO2011/076396 and may be considered here. Various methods for preparing and incorporating carbon sublayers are well known in the art and can be employed to incorporate a carbon sublayer in accordance with the preceding. Further, the carbon sublayers and the selectively conductive layers may be applied and incorporated in any order, either discretely or to any appropriate adjacent component) in assembling the fuel cell.

Without being bound by theory, it is believed that contact between the selectively conducting material in the selectively conducting layer and components in the anode may result in an adverse effect on the former. In that regard then, the carbon sublayer may serve as a separation layer.

The following Examples have been included to illustrate certain aspects of the invention but should not be construed as limiting in any way.

### EXAMPLES

Various experimental fuel cells were prepared with selectively conducting layers (for purposes of startup and shutdown durability) and were then subjected to voltage reversal tolerance testing and performance testing to compare these characteristics. The series included several comparative fuel cells, including a series in which the selectively conducting layer only partially covered the gas diffusion layer, as well as fuel cells comprising different combinations of selectively conducting layers and carbon sublayers.

The cells all comprised catalyst coated membrane electrolytes (CCMs) sandwiched between anode and cathode gas diffusion layers (GDLs) comprising commercial carbon fibre paper from Freudenberg. (In many cases, complete GDLs were obtained commercially from Freudenberg.) The CCMs all had membrane electrolytes made of 18 micrometer thick perfluorosulfonic acid ionomer which had been coated on opposite sides with the desired anode and cathode catalyst layers. The catalyst used in the conventional carbon supported platinum (Pt/C) cathode and anode catalyst layers was a commercial product comprising about 46% Pt by weight. The coated catalyst layer in the cathodes and anodes comprised about 0.4 and 0.1 mg/cm² of Pt respectively.

The selectively conducting layers used in the experimental cells comprised either SnO₂ (obtained from SkySpring Nanomaterials Inc. and characterized by particle sizes between 50 and 70 nm and a surface area between 10 and 30 m²/g) or a proprietary 1% Pt—SnO₂ composition obtained from a commercial supplier in which the Pt was deposited on the SnO₂. These selectively conducting oxide layers (SOx layers) were incorporated as coatings on one of the sides of the anode GDLs as indicated. The coatings were applied using a solid-liquid ink dispersion comprising a mixture of the SnO₂ or Pt—SnO₂, METHOCEL™ methylcellulose polymer, distilled water, and isopropyl alcohol. PTFE was included as a binder in the dispersions. The dispersions were then applied, dried, and sintered as described in the aforementioned PCT patent application WO2011/076396. The thickness of a single application of a selectively conducting anode layer was in the range from about 10-15 micrometers.

The cells also all comprised one or more carbon sublayers in their anode construction. In some cases, the carbon sublayers had been included on the commercially obtained carbon fibre paper used in the GDLs. In other cases, carbon sublayers comprising either acetylene black (from Denka), or synthetic graphite (KS4 from Timcal) were applied as coatings using appropriate solid-liquid ink dispersions in a similar manner as the SOx layers above were applied. The thickness of these carbon sublayers was between about 3 and 10 micrometers.

Assemblies comprising the appropriate CCMs, SOx layers, carbon sublayers, and anode and cathode GDLs were then bonded together under elevated temperature and pressure and placed between appropriate cathode and anode flow field plates to complete the experimental fuel cell constructions.

Cells were then conditioned by operating at a current density of 1.5 A/cm², with hydrogen and air as the supplied reactants at 100% RH, and at a temperature of 60° C. for at least 16 hours. Performance characteristics were determined by measuring output voltage as a function of current density applied otherwise under the same conditions as above. The current density was varied from 0 to over 2 A/cm² and voltage versus current density plots (polarization plots) were generated.

The voltage reversal testing involved operating the cells first at a lower current density of 1 A/cm² for 2 hours, then turning off the current, switching the reactant supply to the anode from hydrogen to nitrogen instead, and then forcing 0.2 A/cm² from the cell, thereby subjecting the cells to voltage reversal conditions. Typically, the cell voltage would roughly plateau at a value between 0 and about −3 volts for a variable amount of time and then drop off suddenly to a value much less than −5 V, at which point testing ended. The length of time to this sudden drop off point is representative of the cell's ability to tolerate voltage reversal and is denoted in the following as the reversal time.

Example Series with Partial Selectively Conducting Oxide Layer (SOx Layer)

A series of nine experimental fuel cells was prepared in which SnO₂-based selectively conducting layers were applied to a varying extent over the surface of the gas diffusion layers adjacent the anodes. The anode GDLs in all these cells had carbon sublayers included on the commercially obtained carbon fibre paper and thus the SOx layers had been applied onto these carbon sublayers. In this series, a comparative fuel cell was prepared in which a SnO₂-based selectively conducting layer was applied over the whole anode GDL surface. Also in this series, a comparative fuel cell was prepared in which there was no selectively conducting layer at all. And the remaining cells in the series had selectively conducting layers applied only over a portion of the anode GDL surface as suggested in WO2011/076396 in order to improve tolerance to voltage reversal.

A variety of patterns were also used in preparing the cells with the partial SOx layers. In total, the patterns included: no coverage at all, complete coverage, complete coverage of ⅔ of the anode GDL surface near the reactant outlets, complete coverage of ⅓ of the anode GDL surface near the reactant outlets, stripes in the direction of reactant flow (i.e. the “long” direction), stripes transverse to the direction of reactant flow (i.e. the “short” direction), stripes transverse to the direction of reactant flow only over ⅓ of the anode GDL surface near the reactant outlets, a checkerboard pattern, and a pattern of 3 small squares. The % of open area (i.e. the GDL area not covered with selectively conducting material) thus varied from 0 to 100%. These cells (in order of increasing open or uncovered area) and their coverage patterns are summarized in Table 1 below.

TABLE 1

| Cell # | Coverage pattern of selectively conducting oxide layer |
|---|---|
| A1 | complete coverage |
| A2 | complete coverage of ⅔ of the anode GDL surface near the |
| | reactant outlets |
| A3 | stripes in the direction of reactant flow |
| A4 | stripes transverse to the direction of reactant flow |
| A5 | complete coverage of ⅓ of the anode GDL surface near the |
| | reactant outlets |
| A6 | checkerboard pattern |
| A7 | 3 small squares |
| A8 | stripes transverse to the direction of reactant flow only over ⅓ |
| | of the anode GDL surface near the reactant outlets |
| A9 | no coverage at all |

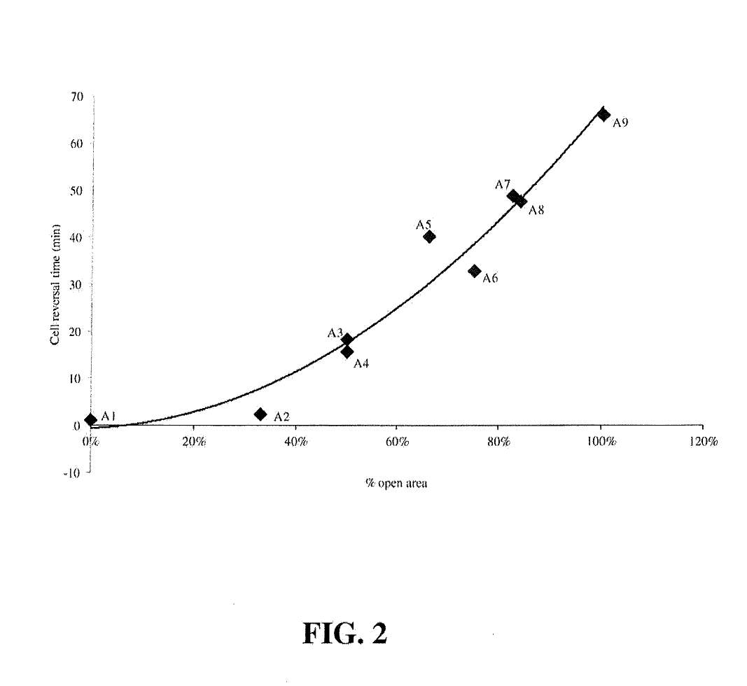

FIG. 2 shows a plot of the reversal time observed as a function of the % open (uncovered) area of the anode GDL surface for these various fuel cells. The line in FIG. 1 is a least squares quadratic fit to the data obtained. These examples demonstrate that, as expected, reversal time improves as open area increases and approaches that of a fuel cell with no selectively conducting layer at all. However, for this fuel cell design, a substantial % of open area seems required in order to achieve reversal times of order of that for a cell with no selectively conducting layer (e.g. >60% open area is required to obtain reversal times over ½ that for a cell with no selectively conducting layer). Thus, while effective, increasing the open area may involve a significant trade-off in either the potential durability on startup and shutdown or on the potential tolerance to voltage reversal.

Example Series with Varied Carbon Sublayers and SOx Layers

A series of twelve experimental fuel cells was prepared having different combinations of carbon sublayers and SOx layers. In all cells comprising SOx layers, the SOx layers were applied over an entire surface of the anodes (i.e. full coverage). The series included a conventional fuel cell with no SOx layer (cell B1) and conventional fuel cells provided with a SOx layer adjacent the anode catalyst layer (cells B2 and B11). The other cells in the series had SOx layers that were not adjacent the anode catalyst layer and were separated therefrom in various manners. In cell B3, the SOx layer was provided between the GDL and the flow field plate and thus the GDL separated the SOx layer from the anode catalyst layer. Cells B4, B8, and B9 had a coated carbon sublayer between the anode catalyst layer and the SOx layer, but did not have a conventional carbon sublayer on the GDL surface. The type of carbon used and the number of coatings applied (and hence the thickness) of the carbon sublayer varied from cell to cell. In a like manner, cells B5 to B7, B10, B12, and B13 had a carbon sublayer provided between the anode catalyst layer and the SOx layer and in addition had a conventional carbon sublayer on the GDL surface. Again, the type of carbon used and the number of coatings applied varied from cell to cell. The SOx layers in cells B2 to B10 comprised SnO₂ while those in cells B11 to B13 comprised 1% Pt—SnO₂.

The cells were subjected to voltage reversal testing and performance testing as detailed above. Table 2 provides a brief description of the anode components in each cell and summarizes the results of these tests. In particular, the reversal time observed is given in minutes and the output voltage at a representative current density of 1.5 A/cm² is also given.

TABLE 2

| | Anode components (in order from membrane | Reversal time | Output voltage |
|---|---|---|---|
| Cell# | electrolyte) | (min) | @ 1.5 A/cm² |
| B1 | anode catalyst layer; commercial GDL (with | 77 | 0.602 |
| | carbon sublayer on carbon fibre paper) | | |
| B2 | anode catalyst layer; SnO₂ based SOx layer; | 0.33 | 0.577 |
| | commercial GDL (with carbon sublayer on | | |
| | carbon fibre paper) | | |
| B3 | anode catalyst layer; commercial GDL (with | 83 | 0.272 |
| | carbon sublayer on carbon fibre paper); SnO₂ | | |
| | based SOx layer | | |
| B4 | anode catalyst layer; coated Denka black | 65 | 0.414 |
| | sublayer; SnO₂ based SOx layer; commercial | | |
| | carbon fibre paper | | |
| B5 | anode catalyst layer; 1 x coated Denka black | 50 | 0.396 |
| | sublayer; SnO₂ based SOx layer; commercial | | |
| | GDL (with carbon sublayer on carbon fibre | | |
| | paper) | | |
| B6 | anode catalyst layer; 6 x coated Denka black | 59 | 0.404 |
| | sublayer; SnO₂ based SOx layer; commercial | | |
| | GDL (with carbon sublayer on carbon fibre | | |
| | paper) | | |
| B7 | anode catalyst layer; 6 x coated Denka black | 66 | 0.311 |
| | sublayer; SnO₂ based SOx layer; commercial | | |
| | GDL (with carbon sublayer on carbon fibre | | |
| | paper) | | |
| B8 | anode catalyst layer; 3 x coated Denka black | 65 | 0.468 |
| | sublayer; SnO₂ based SOx layer; commercial | | |
| | carbon fibre paper | | |
| B9 | anode catalyst layer; 3 x coated Denka black | 59 | 0.417 |
| | sublayer; SnO₂ based SOx layer; commercial | | |
| | carbon fibre paper | | |
| B10 | anode catalyst layer; 1 x coated KS4 graphite | 62 | 0.360 |
| | sublayer; SnO₂ based SOx layer; commercial | | |
| | GDL (with carbon sublayer on carbon fibre | | |
| | paper) | | |
| B11* | anode catalyst layer; 1% Pt—SnO₂ based SOx | <4* | Not applicable |
| | layer; commercial GDL (with carbon sublayer on | | |
| | carbon fibre paper) | | |
| B12 | anode catalyst layer; 1 x coated Denka black | 57 | 0.515 |
| | sublayer; 1% Pt—SnO₂ based SOx layer; | | |
| | commercial GDL (with carbon sublayer on | | |
| | carbon fibre paper) | | |
| B13 | anode catalyst layer; 1 x coated Denka black | 74 | 0.552 |
| | sublayer; 1% Pt—SnO₂ based SOx layer; | | |
| | commercial GDL (with carbon sublayer on | | |
| | carbon fibre paper) | | |

*Note: cell B11 was not of quite the same construction as the other cells in this series. Quantitative comparisons are thus not appropriate. Qualitatively however it is clear that this cell had poor reversal time.

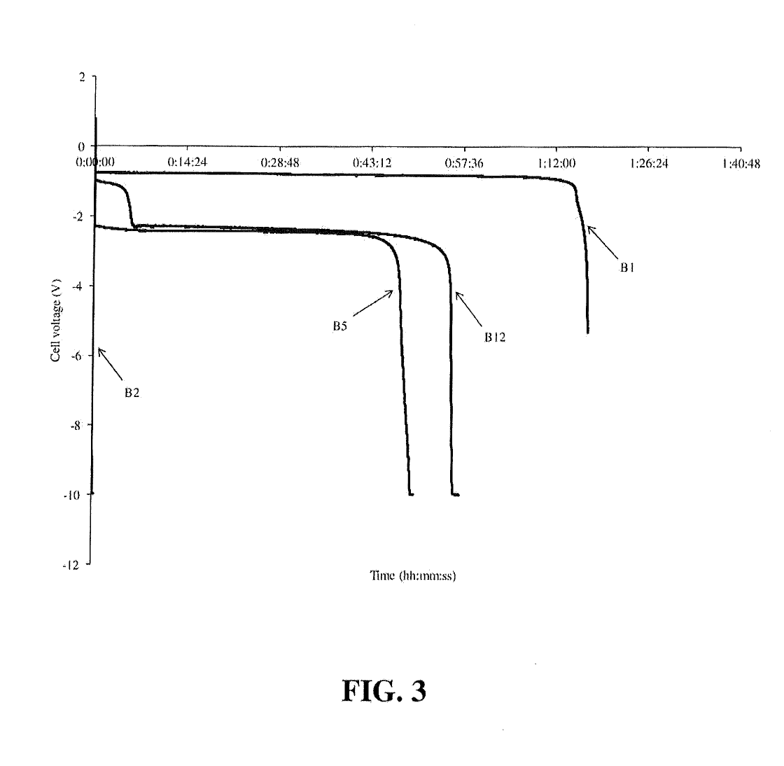

FIG. 3 shows plots of fuel cell voltage versus time during voltage reversal testing for some representative cells in this series (i.e. fuel cells B1, B2, B5 and B12). As is evident from FIG. 2, the design of the fuel cells used in this series is such that long times in reversal can be tolerated if no SOx layer is employed (e.g. cell B1). However, a fuel cell employing a SOx layer and no carbon sublayer in accordance with the invention (e.g. cell B2) cannot tolerate reversal for any significant time. On the other hand, cells comprising SOx layers (either SnO₂ or 1% Pt—SnO₂) and a carbon sublayer in accordance with the invention can tolerate reversal for substantial periods of time (e.g. cells B5 and B12).

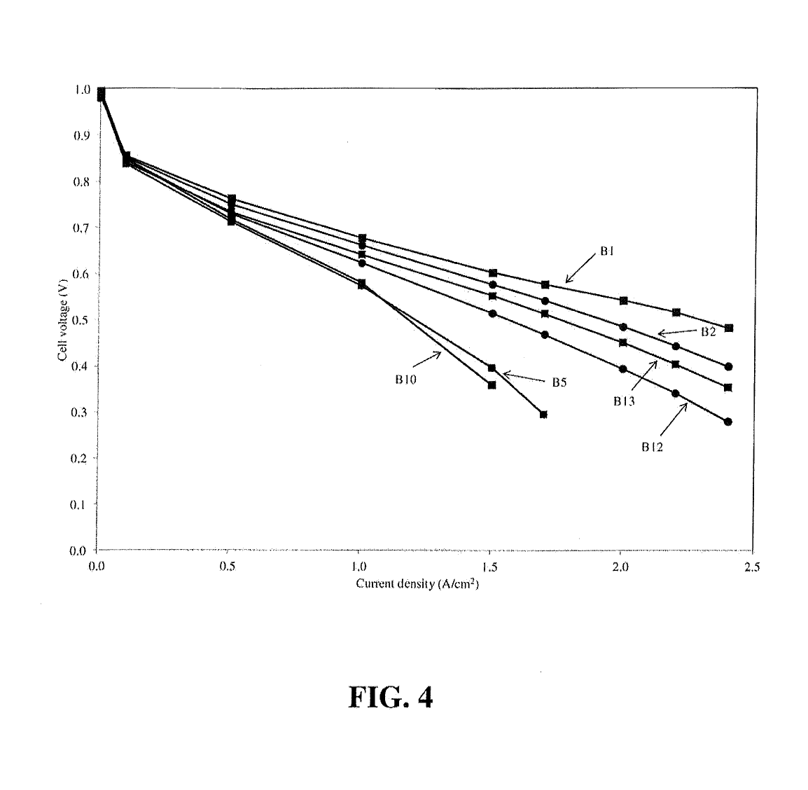

FIG. 4 shows polarization plots (fuel cell voltage versus current density) for some representative cells in this series (i.e. fuel cells B1, B2, B5, B10, B12 and B13). As can be seen from FIG. 4, a performance trade-off can result when incorporating a SOx layer in the fuel cell (comparing cell B2 to cell B1). The performance trade-off can be greater however when also incorporating a carbon sublayer adjacent the anode (comparing cells B5, B10, B12 and B13 to cell B2). However, the cells with SOx layers based on 1% Pt—SnO₂ have acceptable and significantly better performance than the cells with SOx layers based on SnO₂ (comparing cells B12 and B13 to cells B5 and B10).

The results shown in Table 2 and FIGS. 3 and 4 illustrate that cells comprising a 1% Pt—SnO₂ based SOx layer and a carbon sublayer in contact with the side of the anode opposite the solid polymer electrolyte have both acceptable reversal tolerance and performance (i.e. >0.5 V at 1.5 A/cm²) while enjoying the startup/shutdown benefits of using a SOx layer. On the other hand, cells comprising a SnO₂ based SOx layer and a similar carbon sublayer can have acceptable reversal tolerance but relatively poor performance. A cell comprising a SOx layer but no such carbon sublayer can suffer from poor tolerance to voltage reversal. And of course, a cell absent a SOx layer does not obtain the associated durability improvement with respect to startup and shutdown.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. For instance, the invention is not limited just to fuel cells operating on pure hydrogen fuel but also to fuel cells operating on any hydrogen containing fuel or fuels containing hydrogen and different contaminants, such as reformate which contains CO and methanol. Such modifications are to be considered within the purview and scope of the claims appended hereto.

What is claimed is:

1. A solid polymer electrolyte fuel cell comprising a solid polymer electrolyte, a cathode, and anode components connected in series electrically wherein:
i) the anode components comprise an anode, an anode gas diffusion layer, and a selectively conducting component;
ii) the selectively conducting component comprises a selectively conducting material; and
iii) the electrical resistance of the selectively conducting component in the presence of hydrogen is more than 100 times lower than the electrical resistance in the presence of air; characterized in that the anode components comprise a carbon sublayer in contact with the side of the anode opposite the solid polymer electrolyte; and
the selectively conducting material and carbon sublayer are selected such that the fuel cell voltage is greater than about 0.5 V when operating at 1.5 A/cm².

2. The fuel cell of claim 1 wherein the electrical resistance of the selectively conducting component in the presence of hydrogen is more than 1000 times lower than the electrical resistance in the presence of air.

3. The fuel cell of claim 1 wherein the selectively conducting material comprises a noble metal deposited on a metal oxide.

4. The fuel cell of claim 3 wherein the selectively conducting material comprises platinum deposited on tin oxide.

5. The fuel cell of claim 4 wherein the selectively conducting material comprises about 1% Pt—SnO₂.

6. The fuel cell of claim 1 wherein the selectively conducting component is incorporated as a layer on the side of the anode gas diffusion layer adjacent the carbon sublayer.

7. The fuel cell of claim 1 wherein the selectively conducting component is incorporated as a layer on the side of the anode gas diffusion layer opposite the carbon sublayer.

8. The fuel cell of claim 1 wherein the thickness of the selectively conducting component is in the range from about 10 to about 15 micrometers.

9. The fuel cell of claim 1 wherein the carbon sublayer comprises acetylene black or synthetic graphite.

10. The fuel cell of claim 1 wherein the thickness of the carbon sublayer is in the range from about 3 to about 10 micrometers.

11. A method for increasing the tolerance of a solid polymer electrolyte fuel cell to voltage reversal, the solid polymer electrolyte fuel cell comprising a solid polymer electrolyte, a cathode, and anode components connected in series electrically wherein:
i) the anode components comprise an anode, an anode gas diffusion layer, and a selectively conducting component;
ii) the selectively conducting component comprises a selectively conducting material; and
iii) the electrical resistance of the selectively conducting component in the presence of hydrogen is more than 100 times lower than the electrical resistance in the presence of air; and the method comprising:
incorporating a carbon sublayer in contact with the side of the anode opposite the solid polymer electrolyte; and
selecting the selectively conducting material and carbon sublayer such that the fuel cell voltage is greater than about 0.5 V when operating at 1.5 A/cm².

12. The method of claim 11 comprising selecting a noble metal deposited on a metal oxide for the selectively conducting material.

13. The method of claim 11 comprising incorporating the selectively conducting component as a layer on the side of the anode gas diffusion layer adjacent the carbon sublayer.

14. A fuel cell stack comprising the fuel cell of claim 1.

15. A vehicle comprising a traction power supply comprising the fuel cell stack of claim 14.
